(19) United States
(12) Patent Application Publication
(10) Pub. No.: US 2007/0065937 A1
(43) Pub. Date: Mar. 22, 2007

(54) System and method for composting

(76) Inventor: Shokry Rashwan, Niverville (CA)

Correspondence Address: Ade & Company, 1700-360 Main Street, Winnipeg, MB, R3C 3Z3, CA

(21) Appl. No.: 11/228,409

(22) Filed: Sep. 19, 2005

(51) Int. Cl. C05F 11/08

(52) U.S. Cl. 435/290.1; 435/290.3; 435/300.1; 71/8

(57) ABSTRACT

A system and method for composting involving air directed from the interior of a livestock housing to an area which surrounds material to be composted in a composting container located in close proximity to the livestock housing. Air is preferably directed from the livestock housing to the area surrounding the material to be composted by directing the air through an air transfer duct. The air transfer duct is an insulated flexible duct coupled to the exhaust of the livestock housing ventilation system.

### FIELD OF THE INVENTION

The present invention relates to a composting system and more particularly relates to a method of composting in which air from a livestock housing is used to provide some heat and moisture to the composting process.

### BACKGROUND

Disposing of animal mortalities is becoming a challenge to livestock producers, meat processing plants and slaughterhouses. The reason is the declining demand for rendering due to governments regulations limiting the use of processed carcasses in livestock feed. One of the safest, most economical and ecological alternatives for disposing of mortalities is composting. Most conventional composting is done in sheds, with or without roofs, where dead animals are stacked in piles with a large quantities of wood shaving or straw and water is added on an as needed basis. The composting process goes through two stages of composting. The first stage lasts for an average of two to three months following addition of the last carcass in the pile. During this stage an anaerobic decomposition occurs very slowly and carcasses break down and form, along with the bulking material, a semi compost substance that does not include any flesh or bodily fluids. Continuous attention must be given during this period to prevent leaching of such fluids into the soil. Material is then moved to another bin, within the shed, where it is subject to continuous aeration by rotating periodically. This second stage allows the material to fully compost and lasts for an average of two to three months. Due to the extremely cold climates experienced in northern areas, this process comes to a halt during wintertime. This method also requires extensive quantities of bulking material to continually cover carcasses and prevent intrusion of scavengers, flies and rodents.

Various designs of composters are known in the prior art, including U.S. Pat. No. 6,397,492 to Malley, U.S. Pat. No. 6,001,641 to Posselius Jr. et al, U.S. Pat. No. 5,925,561 also to Posselius Jr. et al, U.S. Pat. No. 5,776,768 to Seymour et al, U.S. Pat. No. 5,759,850 to Seymour, U.S. Pat. No. 5,534,437 to Arrau, U.S. Pat. No. 5,899,803 to Welch, U.S. Pat. No. 5,589,391 to Fink and finally U.S. Pat. No. 5,300,438 to Augspurger et al. The prior art examples of composters are either not operable in extreme cold climates or involve complex monitors and heating systems in order to maintain adequate temperature for the composting process therein. The addition of heating units and operation thereof is costly and not typically feasible for continuous disposal of animal mortalities in a livestock operation.

### SUMMARY

According to one aspect of the present invention there is provided a composting system comprising:

a container situated in proximity to a livestock housing for receiving material to be composted therein; and

a ventilation system coupled to the livestock housing such that air from within the livestock housing is directed to a surrounding area which surrounds the material to be composted in the container.

According to a second aspect of the present invention there is provided a method of composting comprising:

locating a composting container in proximity to a livestock housing placing material to be composted in the composting container;

directing air from the livestock housing to a surrounding area which surrounds the material to be composted in the container.

The use of air from a livestock housing which is directed to the area surrounding the composter provides the addition of heat and moisture from the air of the livestock housing the composting area. The recycled heat reduces cost of composting as no additional heating equipment is needed for operation in cold climates.

Preferably, air is directed from an existing ventilation exhaust of the livestock housing to the surrounding area. In this instance no additional air handling equipment is needed to push the ventilation air through the composter as air is already flowing under pressure out of the existing exhaust of the livestock housing.

Preferably the air is directed through an insulated duct from the livestock housing to the surrounding area into an interior of the container.

When the container is supported for rotation, communication of the air from the livestock housing to the container is preferably selectively separable for disconnection when the container is rotating. The air from the ventilation system may communicate through an end wall of the container at an axis of rotation of the container in this instance.

A discharge gate of the container is preferably located at an opposing end wall of the container in relation to direction of the air from the livestock housing into the container.

When enclosure having walls is provided to surround the container, spaced outwardly from the container, air from the livestock housing is preferably directed into the enclosure.

The livestock housing may comprise a hog barn wherein the material to be composted includes livestock mortalities.

By providing better conditions to the composting process, the total period of composting is shortened from an average five months to less than a week while cutting down the amount of bulking material used by more than fifty percent. The process according to the present invention, unlike that experienced in conventional composting, can be performed continuous all year around even during the extreme cold weather. In the absence of this method, composting is a seasonal and costly activity for livestock producers.

This invention relates to a method and device for processing dead animals carcasses into safe, neutralized and valuable compost in a very short time with very little cost. The process is a continuous operation that involves loading dead animal carcasses into a revolving vessel, monitoring the heat and moisture on continuous basis, adjusting the amounts of bulking material and moisture added accordingly and discharging finished compost in a very short time compared with conventional composting. The material inside the vessel moves very slowly with a speed of one half of a foot per revolution in one direction, from the loading end to the discharge end, with the help of steel paddles mounted on the inside walls of the vessel in a spiral pattern. The monitoring of material temperature, which indicates the speed by which the composting process is progressing, is done automatically using temperature sensors mounted so that they contact the material at different zones in the vessel. Adjustments to the added bulking material (wood shaving or straw) as well as the moisture are done according to the temperature gradient of the material. During extreme cold weather, temperature monitoring assists in activating extracting warm and moist air from the inside of the animal housing to the vessel. The slow rotation of the vessel—approximately four revolutions per hour—ensures a continuous supply of oxygen to the microorganisms responsible for the composting action while controlling the heat inside the vessel so that it does not destroy such microorganisms. The rotation of the vessel is accomplished with mechanically rotating rubber wheels. The wheels, their supports and the vessel are all mounted on a steel skid that can be easily moved around. The greatest advantage of the invention is the ease by which material conditions are controlled which in turn ensures the continuity of the process throughout the severe cold climates with lowest cost.

### BRIEF DESCRIPTION OF THE DRAWINGS

In the accompanying drawings, which illustrate exemplary embodiments of the present invention:

FIG. 1 shows a front view of the composting system in which a loader is unloading carcasses into the feed opening of the compost container.

FIG. 2 is a top plan view of the composting container illustrating loading openings and a service platform.

FIG. 3 is a side elevational view of the system shown in FIG. 2, showing the supporting skid, rotating rubber wheels, a temperature sensing system and a vessel supporting skid.

FIG. 4 is a cross sectional end elevational view of the system of FIG. 2 illustrating paddles and a moisture supply pipeline within the container.

FIG. 5 is an enlarged sectional view of the moisture supply pipeline.

FIG. 6 is an enlarged sectional view of a temperature sensor.

FIG. 7 is a rear elevational view of the system illustrating a warm air duct from the livestock housing and a discharge conveyor.

FIG. 8 is a schematic elevational view of a further embodiment of the composting system connected to a livestock housing as in the previous embodiment.

### DETAILED DESCRIPTION

Referring to the accompanying drawings, there is illustrated a composting system generally indicated by reference numeral 10. The system 10 is particularly suitable for location beside a livestock housing 12 for disposal of livestock mortalities.

The system 10 includes a composter container 14 in the form of an elongate cylindrical vessel which is supported for rotation about a longitudinal axis. The container 14 is loaded at a front end 16 and discharges composted material at a rear end 18 thereof. Openings are provided in the cylindrical side wall of the container for access to the hollow interior of the container. In particular a carcass loading opening is provided adjacent the front end for loading carcasses and some bulking material therethrough. Additional bulking material loading openings 22 are provided at spaced positions between the front and rear ends of the container 14.

Adjacent the rear end 18, a discharge opening 24 is provided in the cylindrical side wall for discharging the composted material out of the container. Doors 26 are provided on each of the openings for selectively closing the opening during operation of the composting system. The carcass loading opening 20 is elongate in the longitudinal direction and includes a plurality of the doors 26 operable independently of one another for enclosing the openings. Each of the doors 26 at the carcass loading opening 20 is curved to be continuous in profile with the cylindrical side wall of the container. The remaining doors are smaller and flat and adjoin the cylindrical side wall by a suitable mounting collar.

The composting container 14 is supported for rotation about its longitudinal axis by supporting the cylindrical side wall on wheels 28. The wheels 28 are supported in pairs on posts 30 which form part of a frame supported on a skid 32 so that the composting system 10 is portable by displacing the skid from one location to another. A motor 34 and suitable gear box are situated on the skid 32 for connection to the container 14 for driving rotation of the container.

The skid 32 includes a service platform 36 formed of expanded metal which extends alongside the container between the front and rear ends thereof for access to a top side of the container by persons standing on the platform. The skid 32 further includes a collection system in the form of a V-shaped channel 38 spaced below the container and extending the full length thereof in which the opposing sides of the channel 38 extend downwardly and inwardly to drain towards a central apex locating a collector tank 40 therebelow which collects any liquid material falling from the container. A service door 42 is provided at the front end 16 to provide access to the interior of the container as desired.

A conveyor system 44 is provided adjacent the rear end of the container for communication with the discharge opening 24. The conveyor system 44 extends below the composter container so that material deposited from the container falls onto the conveyor system to be carried away onto a pile of composted materials. The conveyor system 44 is driven by a suitable pulley system coupled to the drive wheels which drive rotation of the container about its respective longitudinal axis.

Interior walls of the container 14 include paddles 46 supported thereon which project radially inwardly while being oriented in a spiralling pattern from the front end 16 to the rear end 18 the paddles are oriented to urge the material being composted from the front end to the rear end as the container 14 is rotated.

To assist in the composting process a sprinkler system 48 is provided in the form of an elongate pipe extending along the inner wall of the container 14 in the longitudinal direction thereof in communication with nozzles at longitudinally spaced positions therealong. A supply of water to the elongate pipe causes a spray of moisture to be evenly distributed by the nozzles. Various sensors 50 for measuring temperature or moisture of the material being composted and the like are provided at the inner side walls of the container as well.

An end wall 52 of the container at the rear end 18 includes an opening therein for connection to an air transfer duct 54 concentrically with the axis of rotation of the container. The duct 54 is elongate and flexible, with a thick insulated wall and a hollow interior for directing a flow of air therethrough. The duct is arranged for selective connection to the container for ready separation of the duct from the container when the container is to be rotated during the composting process. The duct communicates air therethrough into an interior of the container 14 directly.

The other end of the duct is coupled to an existing exhaust 56 of the ventilation system 58 of a livestock housing, for example a pig barn. In this arrangement, heat and moisture from the air in the livestock housing can be directed through the duct without additional ventilation equipment being required as air pressure of the flow exiting the exhaust 56 of the existing ventilation system is sufficient to direct a flow of the air into the opening at the end wall 52 at the rear of the container adjacent the discharge opening for surrounding the material to be composted within an area inside the container.

In a further embodiment as illustrated in FIG. 8, an enclosure 60 comprising walls surrounds the composter container 14 in which the walls of the enclosure 60 are spaced outwardly from the container 14. The air transfer duct 54 in this embodiment is connected from the existing exhaust 56 of the ventilation system 58 of the livestock housing 12 directly to the area within the interior of the enclosure 60 and which surrounds the container 14 and compost material therein.

The method of operation of the composting system involves locating the composting container 14 in close proximity to the livestock housing 12 so that air may be directed from the livestock housing to the area surrounding the material to be composted in the container at periodic intervals when heat or moisture are desirably added to the composting process. As described in the above embodiments, air is directed from an existing ventilation exhaust of the livestock housing either directly into the interior of the container or into an interior of an enclosure surrounding the composting container.

The composting process involves placing livestock mortalities through the carcass loading opening in the container along with bulking material. As the composting process progresses the container is periodically rotated to advance the material to be composted towards the rear end. Throughout this process additional bulking material may be added as desired through the bulking material loading openings spaced along the container towards the rear end. Air from the livestock housing is mainly used in colder climates when the temperature falls below a prescribed lower limit of the composting process.

As described above, a method and device for disposing of animal mortalities is provided in which the device is a mobile composting vessel. The composting vessel consists of a slowly rotating steel drum that has steel paddles and a sprinkler pipeline mounted on the inside walls. The paddles are mounted in a spiral shaped pattern to allow material to move in one direction inside the vessel. The water pipeline has sprinklers that, when activated, allow the water to be uniformly distributed inside the vessel. The vessel has loading, and discharge openings. The loading openings used for loading carcasses and bulking material. The discharge opening has a screen that allows only composted material to pass therethrough while stopping large bones from being discharged. The discharged material drops onto a discharge conveyor that conveys compost to a pile. The vessel is connected to the livestock housing ventilation system through a moveable duct. The duct is typically used only in the wintertime and directs warm, moist air from inside the barn to the inside of the vessel. The vessel is equipped with automated temperature sensors that monitor the heat inside the vessel. The vessel is supported on rubber wheel tires that are mechanically driven. Steel posts that are supported by steel skids hold the rubber wheel tires.

As described herein, the composting process begins by loading carcasses and adding properly calculated moisture and bulking material and then rotating the vessel, while continually monitoring heat and moisture inside the vessel. Adjustments to amounts of bulking material and/or the moisture are done according to levels of heat inside the vessel. Controlling these conditions along with the slow movement of material drastically reduces the time of composting. Material reaches the discharge end in less than a week and it is then ready for discharge. Part of the discharged material is recycled into the vessel while the rest is spread on soil to enhance its properties. The composting vessel and the process itself are intended for use to process animal mortalities into high quality compost under very controlled conditions in very short time and with minimum cost.

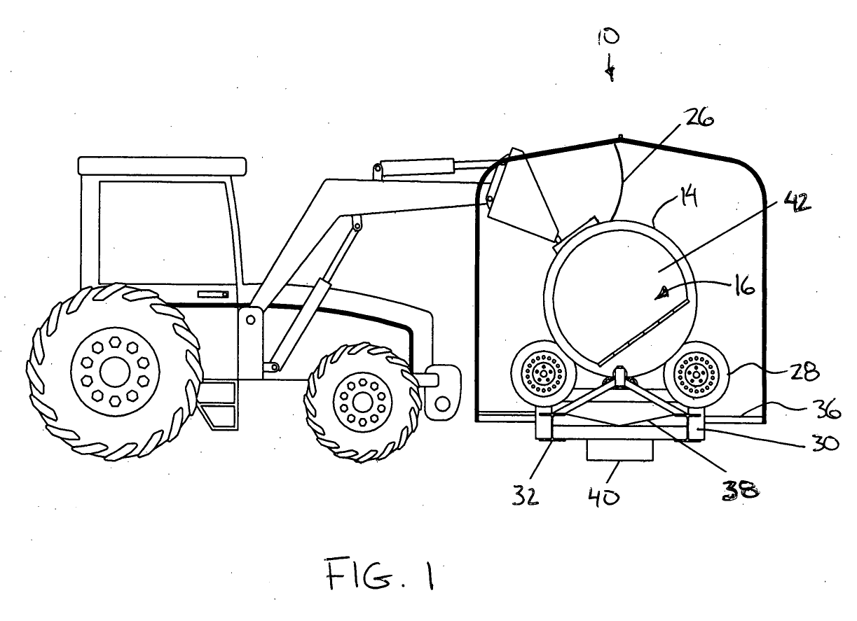

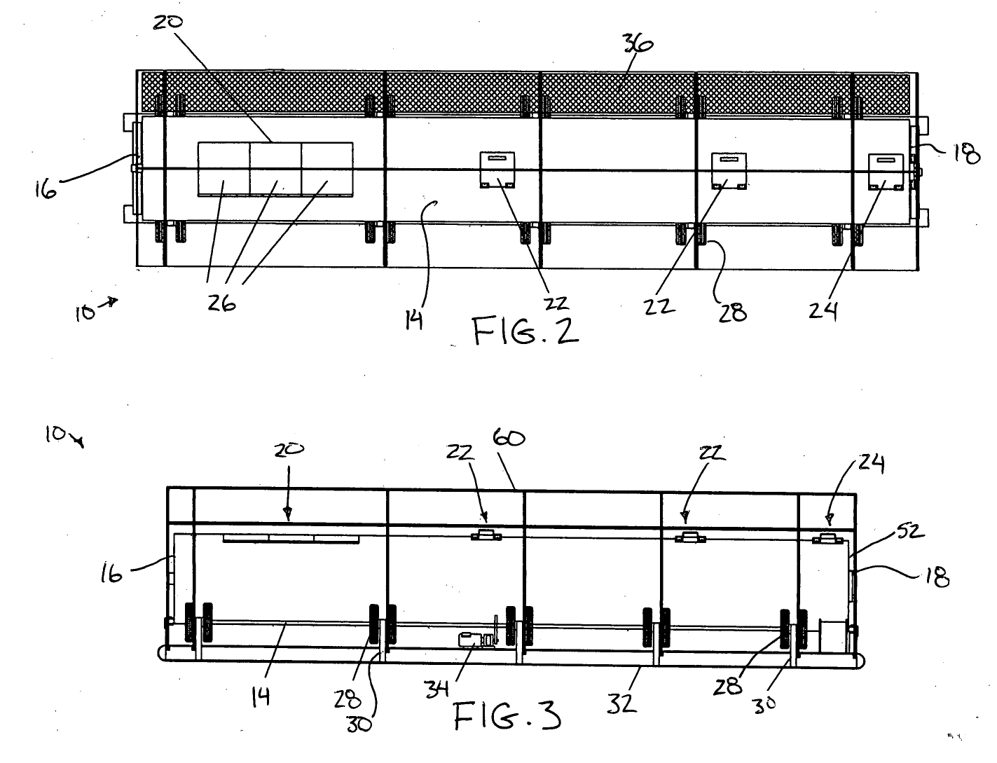

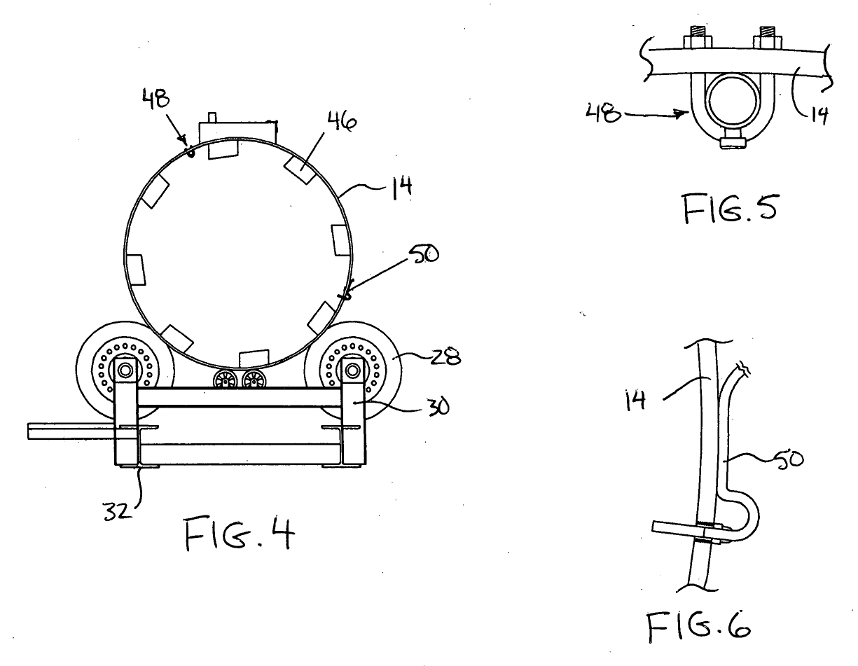

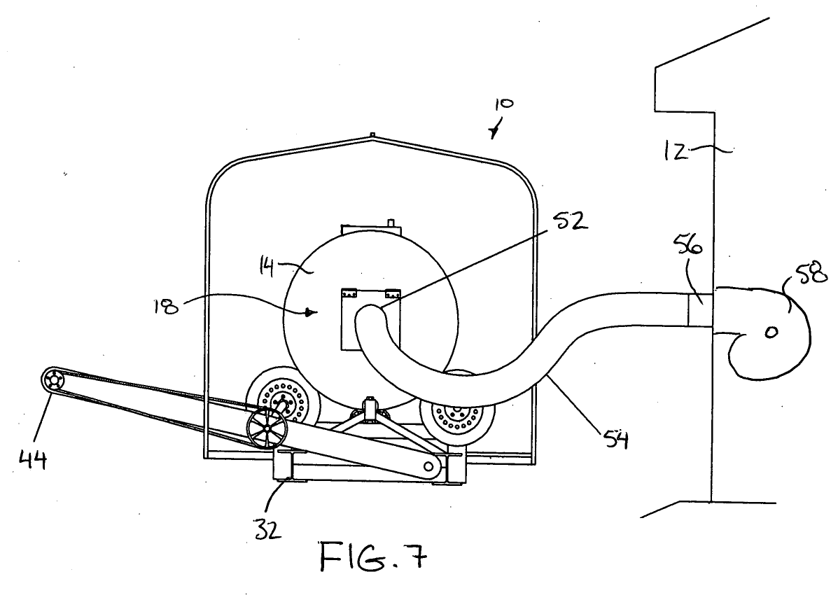

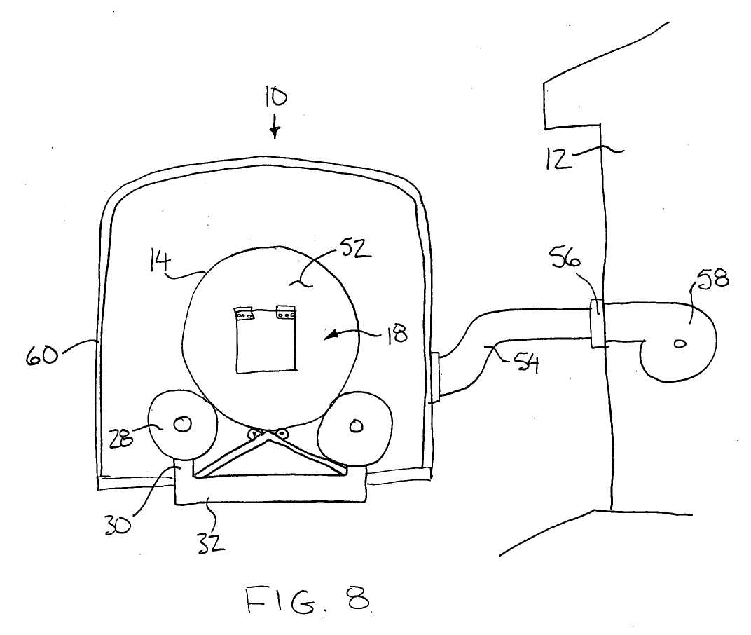

As shown in FIG. 2, the vessel has one carcass loading opening, two bulking material loading openings and a discharge opening. The carcass loading opening has three steel doors 30 with the same curvature as the vessel itself. The bulking material loading openings and the compost discharge openings have flat steel doors mounted on short steel frame. The discharge opening has a screen that, when discharging would allow only compost material with small sizes to pass through. FIG. 1 also shows the service/inspection platform. The platform consists of steel frame and expanded metal. The platform is weld connected to the supporting skid shown in FIG. 3.

The vessel has ten sets of the rubber wheels. Each set consists of two wheels. The wheels are supported by steel posts that are weld connected to the supporting skid. Five wheel sets are shaft driven using a combination of a motor and gearboxes. The vessel has a light steel skeleton that is bolted to the skid and used to support temporary hording during wintertime.

FIG. 1 shows the front view of the vessel. The figure shows a service door at the front. It also shows the carcasses door in an open position. The vessel, as shown in FIG. 1 has V-shaped light gage channel mounted on the skid and sloped slightly from front to the back. The channel is used to collect any liquids that may drain from the vessel and collects it in a container at the back of the vessel.

FIG. 7 shows the back view of the vessel. The vessel has an opening at the back side that is used to connect the warm air ducts from the livestock housing ventilation fan to the inside of the vessel. The figure also shows the discharge conveyor mounted so that it is driven by universal joints connected to the driving wheels.

FIG. 4 is a cross section of the vessel. The figure shows the steel paddles that, when the vessel is rotating, help in moving the material from the front to the back. The figure also shows the water pipeline and sprinkler system used to add uniformly distributed moisture as required by the material inside the vessel. The figure also shows the temperature monitoring system with the wire mounted on the outside wall and sensor tips penetrating the vessel walls and projecting inside the vessel.

The process itself begins with loading carcasses through the loading opening shown in FIG. 1. One, two or three of the loading doors may be opened depending on size of the carcass. The estimated weight of the carcass is then entered into an automated control system that produces the optimum amount of bulking material and moisture to be added depending on such weight as well as type, cost and availability of the bulking material. The control system also produces the estimated amount of compost to be charged after adding the new load of carcasses and bulking material. The purpose of determining this amount, i.e. the amount of compost to be discharged, is to keep the material inside the vessel in a balanced condition where a maximum of three quarters of the vessel is filled at any time. Calculated bulking material is then added through the carcass loading opening as well as bulking material loading openings. Calculated moisture is added through the pipeline and sprinkler system. After all loading doors are closed; the vessel begins rotating on continuous basis and discharging, if needed, would also commence until all material to be removed is discharged and piled outside the vessel waiting for spreading on soil or recycling into the vessel. The automated control system is also connected to the temperature monitoring system. The temperature monitoring system (data logging HOBO with variable time recording ability) records variations in temperature inside the vessel at different zones.

The temperature of the material inside the vessel may follow certain patterns with different levels at different zones. These patterns are indicating that the composting action is progressing properly without destroying the microorganisms responsible for composting or risking putting such microorganisms through a very slow anaerobic action. If temperature records show intolerable deviation from the proper temperature pattern, corrective actions would be instigated. These actions include the following: adjusting moisture content if material in any zone is dryer than specified limits, adding more bulking material if material inside the vessel is too wet or levels of ammonia are high, and finally activating the flow of warm air from the barn exhaust fan system to the inside of the vessel if cold weather slows down or totally stops the activities of the microorganisms.

As the vessel rotates, material moves slowly from the front to the back. This would ensure the flow of material from the loading zone so that new carcasses may be added. This, in turn, ensures the continuity of the process and provides a consistent set of conditions inside the vessel that makes this invention capable of operation through severe climate conditions similar to those known for northern regions.

Having described the invention, modifications will be evident to those skilled in the art without departing from the scope of the invention as defined in the appended Claims.

While some embodiments of the present invention have been described in the foregoing, it is to be understood that other embodiments are possible within the scope of the invention. The invention is to be considered limited solely by the scope of the appended Claims.

1. A composting system comprising:
a container situated in proximity to a livestock housing for receiving material to be composted therein; and
a ventilation system coupled to the livestock housing such that air from within the livestock housing is directed to a surrounding area which surrounds the material to be composted in the container.

2. The system according to claim 1 wherein the ventilation system is coupled to an existing ventilation exhaust of the livestock housing.

3. The system according to claim 1 wherein the ventilation system includes an insulated duct communicating between the livestock housing and the surrounding area.

4. The system according to claim 1 wherein the ventilation system is coupled to the container for communication with an interior of the container.

5. The system according to claim 4 wherein the container is supported for rotation and the ventilation system is coupled to the container for selective separation from the container when the container rotates.

6. The system according to claim 1 wherein the container is supported for rotation and the ventilation system is coupled to an end wall of the container at an axis of rotation of the container.

7. The system according to claim 6 wherein a discharge gate of the container is located adjacent connection of the ventilation system with the container.

8. The system according to claim 1 wherein there is provided an enclosure having walls surrounding the container, spaced outwardly from the container.

9. The system according to claim 1 wherein the ventilation system is connected between the livestock housing and the enclosure.

10. The system according to claim 1 wherein the livestock housing comprises a hog barn.

11. A method of composting comprising:
locating a composting container in proximity to a livestock housing placing material to be composted in the composting container;
directing air from the livestock housing to a surrounding area which surrounds the material to be composted in the container.

12. The method according to claim 11 including directing the air from an existing ventilation exhaust of the livestock housing.

13. The method according to claim 11 including directing the air through an insulated duct from the livestock housing to the surrounding area.

14. The method according to claim 11 including directing air into an interior of the container.

15. The method according to claim 14 including supporting the container for rotation and disconnecting communication of said air from the livestock housing to the container when the container is rotating.

16. The method according to claim 11 including supporting the container for rotation and directing said air through an end wall of the container at an axis of rotation of the container.

17. The method according to claim 11 including directing air from the livestock housing to the surrounding area responsive to temperature in the container falling below a prescribed lower limit.

18. The method according to claim 11 including supporting an enclosure having walls to surround the container, spaced outwardly from the container.

19. The method according to claim 18 including directing said air from the livestock housing into the enclosure.

20. The method according to claim 11 wherein the livestock housing comprises a hog barn.
